(19) United States
(12) Patent Application Publication
(10) Pub. No.: US 2009/0082475 A1
(43) Pub. Date: Mar. 26, 2009

(54) PROCESS FOR DEVULCANIZATION OF RUBBER

(76) Inventors: Yuncan ZHANG, Nanjing (CN); Ji SHEN, Nanjing (CN); Tianju CHEN, Nanjing (CN); Zhixin XU, Nanjing (CN); Xianwang CHEN, Nanjing (CN); Mang ZHANG, Nanjing (CN)

Correspondence Address: MATTHIAS SCHOLL, 14781 MEMORIAL DRIVE, SUITE 1319, HOUSTON, TX, 77079, US

(21) Appl. No.: 12/234,766

(22) Filed: Sep. 22, 2008

(30) Foreign Application Priority Data
Sep. 20, 2007 (CN) 200710132935.5

(51) Int. Cl. C08J 11/12

(52) U.S. Cl. 521/45.5

(57) ABSTRACT

A process for devulcanization of vulcanized rubber, comprising the steps of: (a) preparing a mixture comprising: between about 5% w/w and about 50% w/w of thermoplastic polymer, between about 49% w/w and about 94% w/w of waste vulcanized rubber, and between about 0.01% w/w and about 1.8% w/w of stabilizing agent; and (b) kneading and desulfurizing the mixture by means of a co-rotating twin screw extruder at an extrusion temperature of between 150° C. and 320° C. to obtain devulcanized rubber. The devulcanized rubber is water-cooled, ground and dried or is rolled into sheet. This process combines the devulcanization, milling process and filtrating rubber as one process, possesses a higher devulcanization efficiency, treatment capability and lower energy consumption. Through the present invention, a controllable devulcanization process and a higher performance of the reformed materials with reclaimed rubber are achieved.

### CROSS-REFERENCE TO RELATED APPLICATIONS

This application claims priority benefits to Chinese Patent Application No. 200710132935.5 filed Sep. 20, 2007, the contents of which are incorporated herein by reference.

### BACKGROUND OF THE INVENTION

1. Field of the Invention

The present invention relates to the field of polymers, and particularly to a method for devulcanization and modification of waste tire rubber by mechanical treatment.

2. Description of the Related Art

Enormous numbers of used tires, hoses, belts and other rubber products are discarded annually after they have been worn out during their limited service lifetime. These used rubber products are typically hauled to dump sites because there is very little use for them after they have served their original intended purpose. A limited number of used tires are utilized in building retaining walls, as guards for protecting boats and similar things where resistance to weathering is desirable. However, most used tires, hoses, belts, etc. are simply discarded.

The recycling of cured rubber products presents a challenging problem. This problem arises because in the vulcanization process rubber becomes cross-linked with sulfur. During vulcanization, the crosslinked rubber becomes thermoset and cannot be reformed into other products.

Since the discovery of rubber vulcanization, there has been continued interest in the recycling of cured rubber. A certain amount of cured rubber from tires and other rubber products is shredded or ground to a small particle size and incorporated into various products as filler. For instance, ground rubber can be incorporated in small amounts into asphalt for surfacing roads and parking lots. Small particles of cured rubber can also be included in rubber formulations for new tires and other rubber products. However, it should be understood that recycled rubber serves only in the capacity of filler because it was previously cured and does not co-cure to an appreciable extent with the virgin rubber in the rubber formulation.

Various techniques for devulcanizing cured rubber have been developed. Devulcanization offers the advantage of rendering the rubber suitable for being reformulated and recurred into new rubber articles if it can be carried out without degradation of the rubber. In other words, the rubber could again be used for its original intended purpose. However, none of the dvulcanization techniques previously developed has proven to be commercially viable.

The devulcanization processes include microwave treatment, ultrasonic treatment, milling with additives, and chemical processing. These approaches to devulcanization of rubber tires are difficult and inefficient. Common problems include poor removal of crosslinks, thermal cracking which degrades rubber polymers, added environment impact, high demand for labor, low process efficiency, and complex equipment requirements.

Recently, U.S. Pat. No. 5,672,630 and U.S. Pat. No. 6,316,508 B1 both to Mouri disclosed a method to soften vulcanized rubber by kneading with unvulcanized new rubber at high temperatures. However, this process does not result in a truly devulcanized rubber product.

### SUMMARY OF THE INVENTION

By utilizing the process of this invention, cured rubber is effectively devulcanized by using a twin screw extruding technique, without the need for microwaves, ultrasonic waves, or chemical additives.

This invention is based upon the mechanism that the shear stress acting on the extruded material has the characteristics of direction and strength during the mixture extruding process, when its strength is increased up to the critical value, the stress can induce to breakup the perpendicular molecular chains of the cured rubber network to the direction of the shear stress, but the parallel molecular chains of the network to the direction are not influenced.

It is known that energies of carbon-sulfur and sulfur-sulfur bonds in the cured rubber network are lower than that of carbon-carbon bond and that carbon-sulfur and sulfur-sulfur bonds are more easily broken up by the shear stress during the mixture extruding process. Consequently, under a condition of adding a thermoplastic polymer as a swelling agent and bearing fluid, the cured network of the ground waste tire rubber in the mixture can be selectively broken up by a higher shear stress by increasing the screw rotation speed of a co-rotating twin screw extruder and controlling extrusion temperature, leading to effectively devulcanization of the cured rubber.

Meanwhile, the macroradicals produced from the stress-induced scission of the cured rubber network and the thermoplastic polymer chains can couple with each other, leading to the enhancement of the compatibility and mechanical properties of the extruded product.

In accordance with the invention, based on the weight of the total content, a mixture was prepared comprising between about 5% and about 50% of thermoplastic polymer (as a swelling agent and bearing fluid), between about 49% and about 94% of waste vulcanized rubber, and between about 0.01% and about 1.8% of stabilizing agent. The mixture was kneaded and devulcanized by a co-rotating twin screw extruder with a higher screw rotation speed and a higher shear stress at a temperature of between 150° C. and 320° C. The volatile matter produced in the devulcanization process was taken off by a water-circle vacuum pump. The extruded product was water-cooled, ground, and dried, or, alternatively, was rolled into a sheet.

The term “thermoplastic polymer” is designated to the linear, branched or uncured polymers, which include, without limitation, polyethylene (PE), polypropylene (PP), ethylene-propylene block copolymer (coPP), ethylene-propylene copolymer (EPR), ethylene-butylene copolymer (LLDPE), ethylene-vinyl acetate copolymer (EVA), ethylene-octalene copolymer (POE), ethylene-propylene-diene monomer rubber (EPDM), styrene-ethylenelbuthylene-styrene copolymer (SEBS), uncured natural rubber (NR), uncured styrene-butadiene rubber (SBR), uncured butadiene rubber (BR), or their blends.

The content of thermoplastic polymer in the mixture, based on the weight of the entire mixture, is preferably between about 5% and about 50%. When the content of thermoplastic polymer is significantly less than about 5% by weight, the plasticity and flowability of the extruded blend may be insufficient with the result that the devulcanization is difficult or impossible. On the other hand, content of thermoplastic polymer in the mixture in excess of about 50% do not increase the plasticity and flowability of the extruded product significantly above those achievable at lower content, and merely increase the utilization of thermoplastic polymer and operating costs. More preferably, the content of thermoplastic polymer is between about 15% and about 35%, by weight with respect to the entire mixture, still more preferably between about 20% and about 30%.

The term “waste vulcanized rubber” refers to a used elastomer or a used rubbery substance having sulfur bonds (such as —S—, —S—S—, and —S—S—S—) between carbon main chains of an organic compound or between polymers of silicone rubber. Examples of organic compounds include natural rubber (NR), butadiene rubber (BR), isoprene rubber, butyl rubber, ethylene-propylene rubber (EPR), styrene-butadiene rubber (SBR), chloroprene rubber, nitrile rubber, acrylic rubber, EPDM (ethylene-propylene diene rubber), and mixtures thereof, which are in an unvulcanized form.

Preferably, waste vulcanized rubber is provided in finely divided form, for example at a particle size of between 150 microns and about 5 mm. With larger particle sizes above about 5 mm, mechanical processing difficulties may tend to arise as a result of the persistence of unmasticated particles in the mix, while the use of particles significantly smaller than about 150 microns does not facilitate processing substantially as compared with the results obtained with larger particle sizes, and only increases the materials costs unnecessarily because of the increased energy costs of comminution. More preferable, the rubber particle size is between about 160 and about 1000 microns, still more preferably between about 170 and about 500 microns.

The term “stabilizing agent” refers to a mixture of an antioxidant comprising an organic phenol and a metal stearate, in which the weight ratio of the organic phenol and the metal stearate is between 0.2 and 1.0.

The organic phenol is selected from tetrakis[methylene-3-(3,5-ditertbutyl-4-hydroxypheyl)propionate]methane (Irganox 1010), n-octadecyl-β-(4-hydroxy-3,5-diterbutyl phenyl)propionate (Irganox 1076), 4,4-thiobis-(6-tert-butyl-3-methyl phenol) (Santonox R), or 1,3,5-tris(4-tert-butyl-3-hydroxy-2,6-dimethylbenzyl)1,3,5-triazine-2,4,6-(1H,3H,5H)-trione (Cyanox 1790). The metal stearate is selected from calcium stearate, barium stearate, or zinc stearate.

The co-rotating twin screw extruder with high screw rotation speed and high shear stress has a screw rotation speed of between about 300 rpm and about 1600 rpm, and a ratio of length to diameter of between about 24 and about 60. The screw configuration of the extruder comprises transporting elements, kneading elements, pressuring elements and left rotating elements. The co-rotating twin screw extruder provides a very strong shear stress on the extruded mixture through increasing the screw rotation speed.

Preferably, the screw rotation speed is in range of between about 400 rpm and about 1200 rpm, and the ratio of length to diameter of the screw is between about 32 and about 48. This is critical because at lower speeds than about 300 rpm and/or lower ratios than about 24, the devulcanization of the cured rubber is difficulties and the plasticity and flowability of the extruded product is very poor, while at screw rotation speed of more than 1600 rpm and/or the ratio higher than 60, the rubber polymer chains are very serious degraded, leading to decrease in the mechanical properties of the devulcanized rubber material. More preferably, the screw rotation speed is in range of between about 800 rpm and about 1000 rpm, and the ratio of length to diameter is in range of between about 32 and 48.

The extrusion temperature is controlled at between 150° C. and 320° C., preferably, between 160° C. and 250° C., more preferably, between 180° C. and 220° C . This is critical because at lower temperatures than 150° C., the devulcanization of the cured rubber is difficult and the plasticity and flowability of the extruded product is very poor, while at temperatures higher than 320° C., the rubber polymer chains are very seriously degraded, leading to decrease in the mechanical properties of the devulcanized rubber material.

### BRIEF DESCRIPTION OF THE DRAWINGS

The invention will be described in more detail, by way of example only, with reference to the accompanying drawings, in which:

FIG. 1 shows a schematic diagram of a devulcanization process of the waste vulcanized rubber constituted by a twin screw extrusion system according to one embodiment of the invention;

FIG. 2 shows a schematic diagram of the screw configuration of twin screw extruder A with a diameter of 20 mm and a ratio of length to diameter of 32 according to one embodiment of the invention; and

FIG. 3 shows a schematic diagram of the screw configuration of twin screw extruder B with a 35 mm diameter and a ratio of length to diameter of 45 according to another embodiment of the invention.

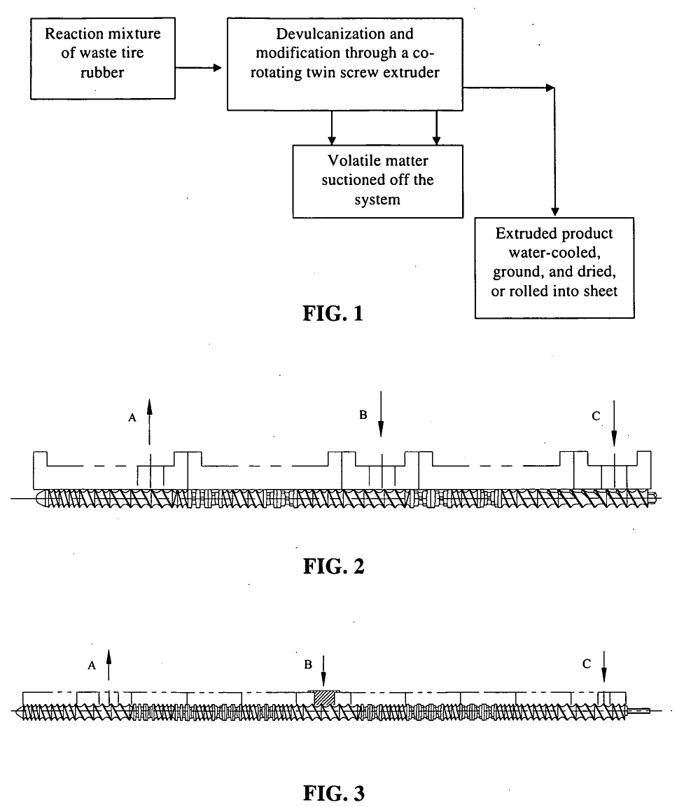

### DETAILED DESCRIPTION OF THE INVENTION

While the above description provides ample information to enable one skilled in the art to carry out the invention, examples of preferred methods will be described in detail without limitation of the scope of the invention.

### EXAMPLE 1

Ground waste tire rubber (about 20 mesh, having a content of 57.3% rubber, 30.1% carbon black, 6.2% ash and 6.4% volatiles) 800 g, EPDM (NDR 3745, obtained from DuPont) 200 g, antioxidant (Irganox 1010) 0.15 g, and calcium stearate 0.3 g were mixed. The mixture was fed into a co-rotating twin screw extruder B with a 35 mm diameter and a ratio of length to diameter of 45 (TE-35, purchased from Coperion Keya Machinery Co. Ltd). The extrusion temperature of 250° C. and screw rotation speed of 1000 rpm were maintained. The volatile matter produced in the devulcanization process was removed by a water-circle vacuum pump. An extruded product, referred to as devulcanized blend DGTR/EPDM, was obtained after water-cooling and drying.

The gel content of the devulcanized blend was measured using the Soxhlet extraction method, in which the extrusion product was packaged with 150-mesh cupro silk cloth and extracted in boiling xylene for 24 h. The residual products were dried under vacuum and then re-weighed and calculated. The gel content of the devulcanized blend was 34%.

The sol of extrusion product solved in xylene was precipitated by acetone, the precipitate was dried and weighted. The intrinsic viscosity number of the sol was determined by viscometry in cyclohexane at 25° C. The intrinsic viscosity number of the sol was 0.217.

The devulcanized blend DGTR/EPDM 30 phr, SBR 70 phr, carbon black (N330) 35 phr, sulfur 2 phr, accelerant TMTD 1.3 phr, ZnO 5 phr, Stearic acid 2 phr and anti-ageing agent D 2 phr were mixed and milled in a roll mill for 10 minutes. The resulting rubber compound was kept for 24 h and then vulcanized at 160° C. and 10 MPa pressure for 6 minutes. The obtained revulcanized rubber sheet was cooled and kept for 24 h at room temperature. (The term “phr” means “parts per hundred parts of resin”.)

In accordance with the testing standard ASTM, the tensile strength, elongation at break, tearing strength and Shore hardness of the revulcanized rubber sheet obtained was 19.5 MPa, 385%, 38.2 kN/m and 69, respectively.

At the extrusion temperature of 250° C., the effect of screw rotation speed on the properties of devulcanized blend and mechanical properties of the revulcanized rubber is shown in Table 1.

TABLE 1
The effect of the screw rotation speed on the properties of devulcanized
blend (DGTR/EPDM) and the mechanical properties of the revulcanized rubber
(SBR/DGTR/EPDM)*

| | Screw | | | | | | |
|---|---|---|---|---|---|---|---|
| | rotation | | Intrinsic | Tensile | | Tearing | |
| | speed | Gel content | viscosity | strength | Elongation | strength | Hardness |
| Number | rpm | wt % | number | MPa | at break % | kN/m | Shore |
| 1-1 | 400 | 43.5 | 0.24 | 17.2 | 360 | 36.1 | 68 |
| 1-2 | 600 | 34.3 | 0.22 | 18.3 | 386 | 39.3 | 68 |
| 1-3 | 800 | 32.7 | 0.27 | 19.0 | 415 | 38.6 | 67 |
| 1-4 | 1000 | 34.0 | 0.22 | 19.5 | 383 | 38.2 | 69 |
| 1-5 | 1200 | 30.4 | 0.23 | 18.7 | 434 | 39.5 | 67 |

*The devulcanization temperature of 250° C.

At the condition of 1000 rpm of screw rotation speed, the effect of extrusion temperature on the properties of devulcanized blend and the mechanical properties of the revulcanized rubber was investigated and is shown in Table 2.

TABLE 2
The effect of devulcanization temperature on the properties of
devulcanized blend (DGTR/EPDM) and the mechanical properties of the revulcanized
rubber (SBR/DGTM/EPDM)*

| | Devulcanization | Gel | Intrinsic | Tensile | | Tearing | |
|---|---|---|---|---|---|---|---|
| | temperature | content | viscosity | strength | Elongation | strength | Hardness |
| Number | ° C. | wt % | number | MPa | at break % | kN/m | Shore |
| 1-6 | 190 | 48.6 | 0.26 | 17.3 | 352 | 36.1 | 68 |
| 1-7 | 210 | 46.4 | 0.23 | 18.3 | 356 | 39.3 | 68 |
| 1-8 | 230 | 40.3 | 0.22 | 18.8 | 366 | 38.6 | 67 |
| 1-9 | 250 | 34.0 | 0.22 | 19.5 | 383 | 38.2 | 69 |
| 1-10 | 270 | 35.0 | 0.21 | 17.2 | 376 | 39.5 | 67 |

*The screw rotation speed of 1000 rpm

The data of Table 1 and Table 2 show that with increase in the screw rotation speed, or with increase of the extrusion temperature, the gel content and the intrinsic viscosity number of the devulcanized blend are significantly decreased, showing that a higher efficiency of devulcanization of the waste tire rubber is reached, and a higher tensile strength and a higher elongation at the breaking point of the revulcanized rubber were obtained at the extrusion condition of 1000 rpm and 250° C.

### EXAMPLE 2

When EPDM was replaced by SBR compound (which contains 33.3% carbon black) in Example 1, the gel content of the devulcanized blend prepared at 800 rpm and 180° C. was 65.4%, the tensile strength, elongation at break, tearing strength and Shore hardness of the revulcanized rubber obtained was 17.1 MPa, 330%, 33.7 kN/m, and 73, respectively.

### EXAMPLE 3

When EPDM was replaced by BR compound (which contains 33.3% carbon black) in Example 1, the gel content of the devulcanized blend prepared at 800 rpm and 180° C. was 70.9%, the tensile strength, elongation at break, tearing strength, and Shore hardness of the revulcanized rubber obtained were 17.0 MPa, 312%, 31.8 kN/m, and 72, respectively.

### EXAMPLE 4

When EPDM was replaced by SEBS thermoplastic elastomer in Example 1, the gel content of the devulcanized blend prepared at 800 rpm and 180° C. was 52.7%, the tensile strength, elongation at break, tearing strength and Shore hardness of the revulcanized rubber obtained were 18.8 MPa, 368%, 34 kN/m and 72, respectively.

### EXAMPLE 5

Ground waste tire rubber (about 10 mesh, having a content of 57.3% rubber, 30.1% carbon black, 6.2% ash, and 6.4% volatiles) 480 g, EPDM (NDR 3745, obtained from DuPont) 120 g, antioxidant (Irganox 1010) 0.12 g, and barium stearate 0.24 g were mixed. The mixture was fed into a co-rotating twin screw extruder B with a 35 mm diameter and a ratio of length to diameter of 45 (TE-35, purchased from Coperion Keya machinery Co. Ltd). The extrusion temperature of 200° C. and screw rotation speed of 1000 rpm were maintained. The volatile matter produced in the devulcanization process was suctioned off by a water-circle vacuum pump. The extruded product, termed devulcanized blend (DGTR/EPDM), was obtained after water-cooling and drying.

The gel content of the devulcanized blend was measured using the Soxhlet extraction method, in which the extrusion product was packaged with 150-mesh cupro silk cloth and extracted in boiling xylene for 24 h. The residual products were dried under vacuum and then re-weighed. The gel content of the devulcanized blend was calculated to be 40.5%.

The devulcanized blend 600 g, polypropylene (PP F401, obtained from Yang Zi chemical Co. Ltd) 400 g, initiator DCP 20 g, sulfur 5 g, accelerant DM 10 g, CZ 5 g and anti-ageing agent D 5 g were mixed. Then, the mixture was fed into a twin screw co-rotation extruder A with a diameter 20 mm and a ratio of length to diameter of 32. Dynamic vulcanization was carried on at the extrusion temperature of 185° C. and screw rotation speed of 150 rpm, the extruded product, termed as dynamically vulcanized elastomer (DGTR/EPDM/PP), was obtained after water-cooling and drying.

The melt flow rate of the dynamic vulcanization elastomer examined in accordance with ASTM is 0.75 g/10 min (at 230° C. and 5 kg load). The testing samples were prepared using injection molding, and the tensile strength, the elongation at break and the Shore hardness of the dynamically vulcanized elastomer obtained were 16.9 MPa, 275% and 95.5, respectively.

At the extrusion temperature of 200° C., the effect of screw rotation speed on the properties of devulcanized blend and the mechanical properties of the dynamically vulcanized elastomer were analyzed and are shown in Table 3.

TABLE 3
The effect of the screw rotation speed on the properties of devulcanized
blend (DGTR/EPDM) and the mechanical properties of the dynamic
vulcanization elastomer (DGTR/EPDM/PP)*

| | Screw | | | | | |
|---|---|---|---|---|---|---|
| | rotation | Gel | Melt flow | Tensile | | |
| | speed | content | rate | strength | Elongation | Hardness |
| Number | rpm | wt % | g/10 min | MPa | at break % | Shore |
| 5-1 | 400 | 50.8 | 0.22 | 18.1 | 215 | 95 |
| 5-2 | 600 | 47.3 | 0.47 | 17.3 | 252 | 96.5 |
| 5-3 | 800 | 40.7 | 0.45 | 16.7 | 260 | 95 |
| 5-4 | 1000 | 40.5 | 0.75 | 16.9 | 275 | 95.5 |
| 5-5 | 1200 | 41.4 | 0.55 | 17.5 | 220 | 97 |

*The devulcanization temperature of 200° C.

At 1000 rpm of screw rotation speed, the effect of devulcanization temperature on the properties of devulcanized blend and the mechanical properties of the dynamically vulcanized elastomer were analyzed and are shown in Table 4.

TABLE 4
The effect of the devulcanization temperature on the properties of
devulcanized blend (DGTR/EPDM) and the mechanical properties of the dynamic
vulcanization elastomer (DGTR/EPDM/PP)*

| | Devulcanization | | Melt | Tensile | | |
|---|---|---|---|---|---|---|
| | temperature | Gel content | flow rate | strength | Elongation | Hardness |
| Number | ° C. | wt % | g/10 min | MPa | at break % | Shore |
| 5-6 | 160 | 46.4 | 0.3 | 15.7 | 228 | 92 |
| 5-7 | 180 | 46.3 | 0.4 | 16.2 | 284 | 93 |
| 5-8 | 200 | 40.5 | 0.75 | 16.9 | 275 | 95.5 |
| 5-9 | 240 | 35.4 | 1.0 | 15.4 | 300 | 95 |
| 5-10 | 260 | 32.4 | 1.2 | 14.3 | 254 | 96 |

*The screw rotation speed of 1000 rpm

The data in Table 3 and Table 4 show that with an increase of the screw rotation speed, or with an increase of the extrusion temperature, the gel content of the devulcanized blend is significantly decreased and the melt flow rate of the blend is increased, showing that a higher efficiency of devulcanization of the waste tire rubber is reached, and a higher tensile strength and a higher elongation at break of the dynamically vulcanized elastomer were obtained at the extrusion condition of 1000 rpm and 200° C.

### EXAMPLE 6

When the ground waste tire rubber (about 10 mesh, having a content of 57.3% rubber, 30.1% carbon black, 6.2% ash, and 6.4% volatile) was replaced by the ground waste tire rubber (about 10 mesh, having a content of 50.0% rubber, 38.6% carbon black, 5.4% ash and 6.0% volatile) in Example 5 and the other composition and conditions were kept the same, the tensile strength, the elongation at break and the Shore hardness of the dynamically vulcanized elastomer obtained were 17.2 MPa, 147%, and 97, respectively.

### EXAMPLE 7

Ground waste tire rubber (about 20 mesh, having a content of 57.3% rubber, 30.1% carbon black, 6.2% ash, and 6.4% volatiles) 500 g, HDPE (5000S, obtained from Yang Zi chemical Co. Ltd) 300 g, antioxidant (Irganox 1010) 0.15 g, and calcium stearate 0.3 g were mixed. The mixture was fed into a co-rotating twin screw extruder A with a 20 mm diameter and a ratio of length to diameter of 32 (TE-20, purchased from Coperion Keya machinery Co. Ltd). The extrusion temperature of 200° C. and screw rotation speed of 600 rpm were maintained. The volatile matter produced in the devulcanization process was suctioned off by a water-circle vacuum pump. The extruded product, termed devulcanized blend (DGTR/HDPE=50/30), was obtained after water-cooling and drying.

The gel content of the devulcanized blend was measured by the Soxhlet extraction method, in which the extrusion product was packaged with 150-mesh cupro silk cloth and extracted in boiling xylene for 24 h. The residual products were dried under vacuum and then re-weighed and calculated. The gel content of the devulcanized blend was 44.9%. The melt flow rate of the devulcanized blend was 0.8 g/10 min (at 230° C. and 5 kg load).

The devulcanized blend (DGTR/HDPE) 80 phr, EPDM (NDR3745, obtained from DuPont) 20 phr, initiator DCP 2 phr, sulfur 0.5 phr, ZnO 4 phr, stearic acid 1.5 phr, accelerant DM 1 phr, CZ 0.5 phr and anti-ageing agent 4010 0.5 phr were mixed and milled in roll mill for 10 minutes. The resulting rubber compound was kept for 24 h and then vulcanized at 160° C. and 10 MPa for 6 minutes. The obtained vulcanized elastomer (DGTR/EPDM/HDPE=50/20/30) was cooled and kept for 24 h at room temperature.

In accordance with the testing standard ASTM, the tensile strength, elongation at break, tearing strength, and Shore hardness of the dynamically vulcanized elastomer obtained were 11.9 MPa, 332%, 58.3 kN/m, and 86, respectively.

At the extrusion temperature of 200° C., the effect of screw rotation speed on the properties of devulcanized blend and the mechanical properties of the dynamically vulcanized elastomer were measured, and are shown in Table 5.

TABLE 5
The effect of the screw rotation speed on the properties of devulcanized
blend (DGTR/HDPE) and the mechanical properties of the dynamic vulcanization
elastomer (DGTR/EPDM/HDPE)*

| | Screw | | Melt | | | | |
|---|---|---|---|---|---|---|---|
| | rotation | | flow | Tensile | | Tearing | |
| | speed | Gel content | rate | strength | Elongation | strength | Hardness |
| Number | rpm | wt % | g/10 min | MPa | at break % | kN/m | Shore |
| 7-1 | 200 | 54.4 | 0.2 | 9.5 | 150 | 67.2 | 88 |
| 7-2 | 400 | 50.8 | 0.3 | 12.8 | 308 | 61.4 | 87.5 |
| 7-3 | 600 | 44.9 | 0.8 | 11.9 | 332 | 58.3 | 86 |
| 7-4 | 800 | 40.7 | 1.2 | 10.8 | 285 | 53.1 | 89 |
| 7-5 | 1000 | 39.7 | 2.2 | 10.1 | 286 | 60.0 | 85 |
| 7-6 | 1200 | 36.5 | 3.2 | 10.4 | 289 | 56.1 | 85 |

*The devulcanization temperature of 200° C.

At 1000 rpm of screw rotation speed, the effect of devulcanization temperature on the properties of devulcanized blend and the mechanical properties of the dynamically vulcanized elastomer were measured, and are shown in Table 6.

TABLE 6
The effect of the devulcanization temperature on the properties of
devulcanized blend (DGTR/HDPE) and the mechanical properties of the dynamically
vulcanized elastomer (DGTR/EPDM/HDPE)*

| | | | Melt | | | | |
|---|---|---|---|---|---|---|---|
| | Devulcanization | Gel | flow | Tensile | | Tearing | |
| | temperature | content | rate | strength | Elongation | strength | Hardness |
| Number | ° C. | wt % | g/10 min | MPa | at break % | kN/m | Shore |
| 7-7 | 150 | 40.4 | 0.7 | 11.8 | 255 | 61.0 | 85 |
| 7-8 | 170 | 40.3 | 0.8 | 11.7 | 272 | 57.5 | 85 |
| 7-9 | 200 | 39.7 | 2.2 | 10.1 | 286 | 60.0 | 85 |
| 7-10 | 230 | 35.2 | 2.8 | 9.3 | 280 | 59.4 | 85 |
| 7-11 | 260 | 31.4 | 4.0 | 8.4 | 260 | 61.1 | 84 |

*The screw rotation speed of 1000 rpm

The data of Table 5 and Table 6 show that with an increase of the screw rotation speed, or with an increase of the extrusion temperature, the gel content of the devulcanized blend is significantly decreased and the melt flow rate of the blend is increased, showing that a higher efficiency of devulcanization of the waste tire rubber is reached, and a higher tensile strength and a higher elongation at break of the dynamically vulcanized elastomer were obtained at the extrusion condition of 600 rpm and 200° C.

### EXAMPLE 8

Ground waste tire rubber (about 10 mesh, having a content of 57.3% rubber, 30.1% carbon black, 6.2% ash, and 6.4% volatiles) 800 g, ethylene-octalene copolymer (POE 6501, obtained from DuPont) 200 g, antioxidant (Irganox 1010) 0.15 g and calcium stearate 0.3 g were mixed. The mixture was fed into a co-rotating twin screw extruder B with a diameter 35 mm and a ratio of length to diameter of 45 (TE-35, purchased from Coperion Keya machinery Co. Ltd). The extrusion temperature of 200° C. and screw rotation speed of 1000 rpm were maintained. The volatile matter produced in the devulcanization process was suctioned off by a water-circle vacuum pump. The extruded product, termed devulcanized blend DGTR/POE, was obtained after water-cooling and drying.

The gel content of the devulcanized blend was measured by the Soxhlet extraction method, in which the extrusion product was packaged with 150-mesh cupro silk cloth and extracted in boiling xylene for 24 h. The residual products were dried under vacuum and then re-weighed. The gel content of the devulcanized blend was calculated to be 39.6%. The melt flow rate of the the devulcanized blend obtained was 12.0 g/10 min.

The devulcanized blend 30 phr, polypropylene (PP J340, obtained from Yang Zi chemical Co. Ltd) 70 phr were mixed. The mixture was fed into a co-rotating twin screw extruder A with a diameter 20 mm and a ratio of length to diameter of 32. Blending was carried on at the extrusion temperature of 190° C. and screw rotation speed of 200 rpm. The extruded product, termed toughened PP (PP/DGTR/POE=70/24/6), was obtained after water-cooling and drying.

In accordance with the testing standard ASTM, testing samples were prepared using injection molding, and the Izod impact strength, the tensile strength, the elongation at break, the flexural strength, flexural modulus, and the melt flow rate of the toughened PP obtained were 47.7 kJ/m², 27.9 MPa, 180% and 16.2 MPa, 707 MPa and 1.5 g/10 min, respectively.

At the extrusion temperature of 200° C., the effect of screw rotation speed on the properties of devulcanized blend and the mechanical properties of the toughened PP were measured, and are shown in Table 7.

TABLE 7
The effect of the screw rotation speed on the properties of devulcanized
blend (DGTR/POE) and the mechanical properties of the toughened PP
(PP/POE/DGTR)*

| | Screw | | Melt | Izod | | | | |
|---|---|---|---|---|---|---|---|---|
| | rotation | Gel | flow | impact | Tensile | | Flexural | Flexural |
| | speed | content | rate | strength | strength | Elongation | strength | module |
| Number | rpm | wt % | g/10 min | kJ/m² | MPa | at break % | MPa | MPa |
| 8-1 | 400 | 54.2 | 4.9 | 31.0 | 29.5 | 81.8 | 16.4 | 690 |
| 8-2 | 600 | 44.2 | 5.5 | 34.9 | 31.0 | 95.6 | 18.1 | 779 |
| 8-3 | 800 | 43.2 | 10.0 | 42.3 | 28.3 | 245 | 16.2 | 690 |
| 8-4 | 1000 | 39.6 | 12.0 | 47.7 | 27.9 | 180 | 16.2 | 707 |
| 8-5 | 1200 | 39.2 | 23.8 | 45.2 | 27.6 | 215 | 15.5 | 667 |

*The devulcanization temperature of 200° C.

At 800 rpm of screw rotation speed, the effect of devulcanization temperature on the properties of devulcanized blend and the mechanical properties of the toughened PP were measured, and are shown in Table 8.

TABLE 8
The effect of the extrusion temperature on the properties of devulcanized
blend (DGTR/POE) and the mechanical properties of the toughened PP (PP/
POE/DGTR)*

| | | | Melt | Izod | | | | |
|---|---|---|---|---|---|---|---|---|
| | Devulcanization | Gel | flow | impact | Tensile | | Flexural | Flexural |
| | temperature | content | rate | strength | strength | Elongation | strength | module |
| Number | ° C. | wt % | g/10 min | kJ/m² | MPa | at break % | MPa | MPa |
| 8-6 | 160 | 46.2 | 5.0 | 41.2 | 29.6 | 107 | 16.3 | 716 |
| 8-7 | 180 | 44.9 | 3.9 | 43.6 | 27.7 | 263 | 16.4 | 694 |
| 8-8 | 200 | 43.2 | 10.0 | 42.3 | 28.3 | 245 | 16.2 | 690 |
| 8-9 | 220 | 43.8 | 12.0 | 44.3 | 27.7 | 306 | 16.8 | 728 |
| 8-10 | 240 | 46.6 | 11.8 | 45.0 | 28.5 | 311 | 16.9 | 729 |
| 8-11 | 260 | 40.7 | 20.0 | 43.0 | 27.6 | 365 | 16.4 | 717 |

*The screw rotation speed of 800 rpm

The data in Table 7 and Table 8 show that with an increase of the screw rotation speed, or with an increase of the extrusion temperature, the gel content of the devulcanized blend is decreased and the melt flow rate of the blend is obviously increased, showing that a higher efficiency of devulcanization of the waste tire rubber is reached, and a higher of Izod impact strength and a higher of elongation at break of the toughened PP were obtained at the extrusion condition of 600 rpm and 200° C.

### COMPARISON EXAMPLE 1

The SBR 100 phr, carbon black (N330) 40 phr, sulfur 2 phr, accelerant TMTD 1.3 phr, ZnO 5 phr, stearic acid 2 phr and anti-ageing agent D 2 phr were mixed and milled in a roll mill for 10 minutes. The resulting rubber compound was kept for 24 h and then vulcanized at 160° C. and 10 MPa for 6 minutes. The obtained vulcanized rubber sheet was cooled and kept for 24 h at room temperature.

In accordance with the testing standard ASTM, the tensile strength, elongation at break, tearing strength and Shore hardness of the vulcanized rubber sheet obtained was 22.0 MPa, 391%, 37.1 kN/m and 63, respectively.

### COMPARISON EXAMPLE 2

Ground waste tire rubber (about 20 mesh, having a content of 57.3% rubber, 30.1% carbon black, 6.2% ash, and 6.4% volatiles) 30 phr, SBR 70 phr, carbon black (N330) 35 phr, sulfur 2 phr, accelerant TMTD 1.3 phr, ZnO 5 phr, Stearic acid 2 phr and anti-ageing agent D 2 phr were mixed and milled in a roll mill for 10 minutes. The resulting rubber compound was kept for 24 h and then vulcanized at 160° C. and 10 MPa for 6 minutes. The obtained vulcanized rubber sheet was cooled and kept for 24 h at room temperature.

In accordance with the testing standard ASTM, the tensile strength, elongation at break, tearing strength, and Shore hardness of the vulcanized rubber obtained were 14.3 MPa, 299%, 37.8 kN/m, and 72, respectively.

The above results compared with each other show that when 30 phr of SBR is replaced by the devulcanized blend prepared at 1000 rpm and 250° C., the tensile strength of the revulcanized rubber sheet reached up to 88% of the vulcanized SBR virgin rubber's, and other properties of the two rubber sheets are closed each other. However, when 30 phr of SBR is replaced by the ground waste tire rubber, the tensile strength of the vulcanized rubber can only reach to 65% of the vulcanized SBR virgin rubber's, and the elongation at break of the vulcanized rubber is also lower.

### COMPARISON EXAMPLE 3

EPDM (NDR 3745, obtained from Dupan Dow chemical Co. Ltd) 600 g, polypropylene (PP F401, obtained from Yang Zi chemical Co. Ltd) 400 g, initiator DCP 20 g, sulfur 5 g, accelerant DM 10 g, CZ 5 g, and anti-ageing agent D 5 g were mixed. Then, the mixture was fed into a twin screw co-rotation extruder A with a diameter 20 mm and a ratio of length to diameter of 32. Dynamic revulcanization was carried on at the extrusion temperature of 185° C. and the screw rotation speed of 150 rpm. The extruded product, termed dynamically vulcanized elastomer (EPDM/PP), was obtained after water-cooling and drying.

The melt flow rate of the dynamically vulcanized elastomer examined in accordance with ASTM was 0.02 g/10 min (at 230° C. and 5 kg load). The testing samples were prepared using injection molding, and the tensile strength, the elongation at break and the Shore hardness of the dynamically vulcanized elastomer obtained were 12.3 MPa, 197% and 90, respectively.

### COMPARISON EXAMPLE 4

Ground waste tire rubber (about 10 mesh) 480 g, EPDM (NDR 3745, obtained from DuPont) 120 g, polypropylene (PP F401, obtained from Yang Zi chemical Co. Ltd) 400 g, initiator DCP 20 g, sulfur 5 g, accelerant DM 10 g, CZ 5 g, and anti-ageing agent D 5 g were mixed. Then, the mixture was fed into a twin screw co-rotation extruder A with a diameter 20 mm and a ratio of length to diameter of 32. Dynamic revulcanization was carried on at the extrusion temperature of 185° C. and screw rotation speed of 150 rpm. Extruded product, termed as dynamically vulcanized elastomer (GTR/EPDM/PP), was obtained after water-cooling and drying.

The melt flow rate of the dynamically vulcanized elastomer examined in accordance with ASTM was 0.34 g/10 min (at 230° C. and 5 kg load). The testing samples were prepared using injection molding, and the tensile strength, the elongation at break, and the Shore hardness of the dynamically vulcanized elastomer obtained were 12.5 MPa, 18%, and 93, respectively.

The above results compared with each other show that the mechanical properties of the dynamically vulcanized elastomer prepared in devulcanization of ground waste tire rubber in this invention are higher than these of the dynamically vulcanized elastomer prepared by virgin rubber of EPDM, and are significantly higher than these of the one prepared by ground waste tire rubber.

### COMPARISON EXAMPLE 5

EPDM (NDR3745, obtained from Dupan Dow chemical Co. Ltd) 70 phr, HDPE (5000S, obtained from Yang Zi chemical Co. Ltd) 30 phr, initiator DCP 2 phr, sulfur 0.5 phr, ZnO 4 phr, stearic acid 1.5 phr, accelerant MD 1 phr, CZ 0.5 phr, and anti-ageing agent D 4010 0.5 phr were mixed and milled in a roll mill for 10 minutes. The resulting rubber compound was kept for 24 h and then vulcanized at 160° C. and 10 MPa for 6 minutes. The obtained the dynamically vulcanized elastomer (EPDM/HDPE=70/30) sheet was cooled and kept for 24 h at room temperature.

In accordance with the testing standard ASTM, the tensile strength, elongation at break, tearing strength, and Shore hardness of the dynamically vulcanized elastomer obtained was 14.0 MPa, 580%, 64.2 kN/m, and 85, respectively.

### COMPARISON EXAMPLE 6

Ground waste tire rubber (about 20 mesh, having a content of 57.3% rubber, 30.1% carbon black, 6.2% ash, and 6.4% volatiles) 50 phr, EPDM (NDR3745) 20 phr, HDPE (5000S) 30 phr, initiator DCP 2 phr, sulfur 0.5 phr, ZnO 4 phr, stearic acid 1.5 phr, accelerant DM 1 phr, CZ 0.5 phr, and anti-ageing agent 4010 0.5 phr were mixed and milled in a roll mill for 10 minutes. The resulting rubber compound was kept for 24 h and then vulcanized at 160° C. and 10 MPa for 6 minutes. The obtained the dynamically vulcanized elastomer (GTR/EPDM/HDPE=50/20/30) sheet was cooled and kept for 24 h at room temperature.

In accordance with the testing standard ASTM, the tensile strength, elongation at break, tearing strength, and Shore hardness of the dynamically vulcanized elastomer obtained were 9.6 MPa, 310%, 66.4 kN/m, and 87, respectively.

The above results compared with each other show that the mechanical properties of the dynamically vulcanized elastomer prepared by devulcanization of ground waste tire rubber in this invention are slightly lower than these of the dynamically vulcanized elastomer prepared by virgin rubber of EPDM, but are significantly higher than these of the one prepared using ground waste tire rubber.

### COMPARISON EXAMPLE 7

In accordance with the testing standard ASTM, the testing samples of PP (J340) were prepared using injection molding and the Izod impact strength, the tensile strength, the elongation at break, the flexural strength, the flexural modulus, and the melt flow rate of the PP obtained were 10.5 kJ/m2, 36.8 MPa, 138% and 33.1 MPa, 1300 MPa, and 2.0 g/10 min, respectively.

### COMPARISON EXAMPLE 8

Ethylene-octalene copolymer (POE 6501, obtained from DuPont) 30 phr, and polypropylene (PP J340, obtained from Yang Zi chemical Co. Ltd) 70 phr were mixed. Then, the mixture was fed into a co-rotating twin screw extruder A with a diameter 20 mm and a ratio of length to diameter of 32. The blending was carried on at the extrusion temperature of 190° C. and screw rotation speed of 200 rpm. The extruded product, termed toughened PP (PP/POE=70/30), was obtained after water-cooling and drying.

In accordance with the testing standard ASTM, the testing samples were prepared using injection molding, and the Izod impact strength, the tensile strength, the elongation at break, the flexural strength, flexural modulus, and the melt flow rate of the toughened PP obtained were no-fracture, 27.2 MPa, 180% and 16.1 MPa, 652 MPa, and 1.3 g/10 min, respectively.

### COMPARISON EXAMPLE 9

Ground waste tire rubber (about 10 mesh, having a content of 57.3% rubber, 30.1% carbon black, 6.2% ash, and 6.4% volatiles) 24 phr, ethylene-octalene copolymer (POE 6501) 6 phr, polypropylene (PP J340) 70 phr were mixed. Then, the mixture was fed into a co-rotating twin screw extruder A with a diameter 20 mm and a ratio of length to diameter of 32. Blending was carried on at the extrusion temperature of 190° C. and screw rotation speed of 200 rpm. The extruded product, termed toughened PP (PP/GTR/POE=70/24/6), was obtained after water-cooling and drying.

In accordance with the testing standard ASTM, the testing samples were prepared using injection molding, and the Izod impact strength, the tensile strength, the elongation at break, the flexural strength, flexural modulus, and the melt flow rate of the toughened PP obtained were 23.7 kJ/m^{2, 26.6} MPa, 34.5%, 18.3 MPa, 772 MPa and 1.3 g/10 min, respectively.

The above results compared with each other show that the Izod impact strength of the toughened PP modified through the devulcanization of ground waste tire rubber in this invention is lower than that of the one modified by virgin POE, but are significantly higher than that of the one modified by ground waste tire rubber.

What is claimed is:

1. A process for devulcanization of vulcanized rubber, comprising the steps of:
(a) preparing a mixture comprising
between about 5% w/w and about 50% w/w of thermoplastic polymer,
between about 49% w/w and about 94% w/w of waste vulcanized rubber, and
between about 0.01% w/w and about 1.8% w/w of stabilizing agent; and
(b) kneading and desulfurizing the mixture by means of a co-rotating twin screw extruder at an extrusion temperature of between 150° C. and 320° C. to obtain devulcanized rubber.

2. The process of claim 1, further comprising suctioning off by a water-circle vacuum pump volatile matter produced in step (b).

3. The process of claim 2, further comprising the steps of (i) water-cooling, grounding, and drying the devulcanized rubber obtained in step (b), or (ii) rolling into sheet the devulcanized rubber obtained in step (b).

4. The process of claim 1, wherein the thermoplastic polymer functions as a swelling agent and bearing fluid.

5. The process of claim 1, wherein the thermoplastic polymer is linear, branched, or un-cured.

6. The process of claim 1, wherein the thermoplastic polymer is polyethylene (PE), polypropylene (PP), ethylene-propylene block copolymer (coPP), ethylene-propylene copolymer (EPR), ethylene-butylene copolymer (LLDPE), ethylene-vinyl acetate copolymer (EVA), ethylene-octalene copolymer (POE), ethylene-propylene-diene monomer rubber (EPDM), styrene-ethylenelbuthylene-styrene copolymer (SEBS), uncured natural rubber (NR), uncured styrene-butadiene rubber (SBR), uncured butadiene rubber (BR), or a blend thereof.

7. The process of claim 1, wherein the vulcanized rubber is a used elastomer or a used rubbery substance having sulfur bonds between carbon main chains of an organic compound or between polymers of silicone rubber.

8. The process of claim 7, wherein the sulfur bonds are selected from —S—, —S—S—, and —S—S—S—.

9. The process of claim 7, wherein said organic compound is natural rubber (NR), butadiene rubber (BR), isoprene rubber, butyl rubber, ethylene-propylene rubber (EPR), styrene-butadiene rubber (SBR), chloroprene rubber, nitrile rubber, acrylic rubber, EPDM (ethylene-propylene diene rubber), or a mixture thereof, which are in an unvulcanized form.

10. The process of claim 9, wherein the vulcanized rubber is provided in a finely divided form at a particle size of between 150 microns and about 5 mm.

11. The process of claim 10, wherein the vulcanized rubber is provided in a finely divided form at a particle size of between about 160 and about 1000 microns.

12. The process of claim 1, wherein the stabilizing agent comprises a mixture of an antioxidant comprising an organic phenol and a metal stearate, the ratio of said organic phenol to said metal stearate being of between about 0.2 and about 1.0.

13. The process of claim 12, wherein
said organic phenol is tetrakis[methylene-3-(3,5-ditertbutyl-4-hydroxypheyl)propionate]methane (Irganox 1010), n-octadecyl-β-(4-hydroxy-3,5-ditertbutyl phenyl)propionate (Irganox 1076), 4,4-thiobis-(6-tert-butyl-3-methyl phenol) (Santonox R), or 1,3,5-tris(4-tert-butyl-3-hydroxy-2,6-dimethylbenzyl)1,3,5-triazine-2,4,6-(1H,3H,5H)-trione (Cyanox 1790), and said metal stearate is calcium stearate, barium stearate, or zinc stearate.

14. The process of claim 1, wherein
the co-rotating twin screw extruder operates at a screw rotation speed of between 300 rpm and 1600 rpm;
the co-rotating twin screw extruder has a ratio of length to diameter of between about 24 and about 60; and
the screw configuration of the co-rotating twin screw extruder comprises transporting elements, kneading elements, pressuring elements, and left rotating elements.

15. The process of claim 14, wherein
the co-rotating twin screw extruder operates at a screw rotation speed of between 400 rpm and 1200 rpm; and
the co-rotating twin screw extruder has a ratio of length to diameter of between about 32 and about 48.

16. The process of claim 1, wherein said extrusion temperature is between 150° C. and 320° C.

17. The process of claim 16, wherein said extrusion temperature is between 160° C. and 250° C.

18. The process of claim 17, wherein said extrusion temperature is between 180° C. and 220° C.
